(19) United States
(12) Patent Application Publication
(10) Pub. No.: US 2016/0351047 A1
(43) Pub. Date: Dec. 1, 2016

(54) METHOD AND SYSTEM FOR REMOTE CONTROL OF ELECTRONIC DEVICE

(71) Applicant: SAMSUNG ELECTRONICS CO., LTD., Suwon-si (KR)

(72) Inventors: Woojung HAN, Seoul (KR); Hyunmi PARK, Seoul (KR); Soohyun LEE, Seoul (KR)

(21) Appl. No.: 15/117,276

(22) PCT Filed: Feb. 23, 2015
(86) PCT No.: PCT/KR2015/001721

§ 371 Date: Aug. 8, 2016

(30) Foreign Application Priority Data
Feb. 21, 2014 (KR) 10-2014-0020937

(51) Int. Cl. G08C 17/02

(52) U.S. Cl. CPC G08C 17/02; G08C 2201/32

(57) ABSTRACT

A method and system for performing remote control between electronic devices is provided. The remote control method includes: detecting, by a first electronic device, a gesture corresponding to a preset gesture; transmitting, by the first electronic device, a remote control message to a second electronic device through a wireless channel established between the first and second electronic devices, wherein the remote control message is a request for transmission of control information for controlling one or more applications or functions running on the second electronic device; receiving the control information from the second electronic device; and displaying a control screen based on the received control information.

### TECHNICAL FIELD

The embodiments of the present invention relate to a method and system for performing remote control between electronic devices.

### BACKGROUND ART

With the rapid development of information and communication technology and semiconductor technology, the use of mobile electronic devices has increased. Electronic devices are equipped with a variety of functions, e.g., a mobile communication function, a short range wireless communication function, a broadcast playback function, an Internet function, etc.

Electronic devices are also equipped with a function for making a connection between electronic devices in wireless mode (i.e., an inter-device wireless-connection function) and a remote control function for remotely controlling electronic devices wirelessly connected to each other (i.e., an inter-device remote control function). The remote control function refers to a function that allows a first electronic device (e.g., a companion device) to remotely control a second electronic device (e.g., a master device).

### DISCLOSURE OF INVENTION

### Technical Problem

In order to control a second electronic device, conventional inter-device remote control methods must turn on the display of a first electronic device and then select one or more of the functions of the second electronic device that will be remotely controlled. That is, conventional inter-device remote control methods require a number of processes to control the second electronic device, which causes user inconvenience.

### Solution to Problem

The present invention has been made in view of the above problems, and provides an remote control method and system that allow users to easily remotely control a second electronic device by using a first electronic device.

In accordance with an exemplary embodiment of the present invention, the present invention provides a remote control method including: detecting, by a first electronic device, a gesture corresponding to a preset gesture; transmitting, by the first electronic device, a remote control message to a second electronic device through a wireless channel established between the first and second electronic devices, wherein the remote control message is a request for transmission of control information for controlling one or more applications or functions running on the second electronic device; receiving the control information from the second electronic device; and displaying a control screen based on the received control information.

In accordance with another exemplary embodiment of the present invention, the present invention provides a remote control method including: receiving, by a second electronic device, a remote control message from a first electronic device through a wireless channel established between the first and second electronic devices, wherein the remote control message is a request for transmission of control information for controlling one or more applications or functions running on the second electronic device; creating control information for controlling one or more applications or functions; and transmitting the created control information to the first electronic device.

In accordance with another exemplary embodiment of the present invention, the present invention provides an electronic device including: a sensor unit for detecting a gesture; a communication unit for establishing a wireless channel with another electronic device; a controller for controlling the communication unit: to transmit, when the detected gesture is a preset gesture, a remote control message to the other electronic device through the wireless channel, wherein the remote control message is a request for transmission of control information for controlling one or more applications or functions running on the other electronic device; and to receive the control information from the other electronic device; and a display for displaying a control screen based on the received control information.

In accordance with another exemplary embodiment of the present invention, the present invention provides a remote control system including: a first electronic device; and a second electronic device connected to the first electronic device through a wireless channel. The first electronic device detects a gesture corresponding to a preset gesture, transmits a request of transmission of control information about one or more applications to the second electronic device through the wireless channel, and receives the control information from the second electronic device. The second electronic device creates control information about one or more applications according to the received request of transmission of control information and transmits the created control information to the first electronic device.

### Advantageous Effects of Invention

As described above, the inter-device remote control method and system according to the embodiments of the present invention allow users to easily remotely control a second electronic device (e.g., a master device) by using a first electronic device (e.g., a companion device) with simple gestures. In addition, the embodiments of the present invention can easily control a number of applications (or functions) that are running on a second electronic device.

### BRIEF DESCRIPTION OF DRAWINGS

The features and advantages of the invention will become more apparent from the following detailed description in conjunction with the accompanying drawings, in which:

FIG. 1 is a network environment including an electronic device according to embodiments of the present invention;

FIG. 2 is a schematic block diagram of an electronic device according to embodiments of the present invention;

FIG. 3 is a flow chart that describes a remote control method of a remote control system according to embodiments of the present invention;

FIG. 4 is a flow chart that describes a remote control method of a first electronic device according to embodiments of the present invention;

FIG. 5 is a flow chart that describes a remote control method of a second electronic device according to embodiments of the present invention;

FIGS. 6 to 9 are views of remote control screens according to embodiments of the present invention; and

FIG. 10 is schematic block diagrams of first and second electronic devices according to embodiments of the present invention.

### MODE FOR THE INVENTION

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure.

In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function and a remote control function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch.

According to some embodiments, the electronic device may be a smart home appliance having a communication function and a remote control function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a communication function and a remote control function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

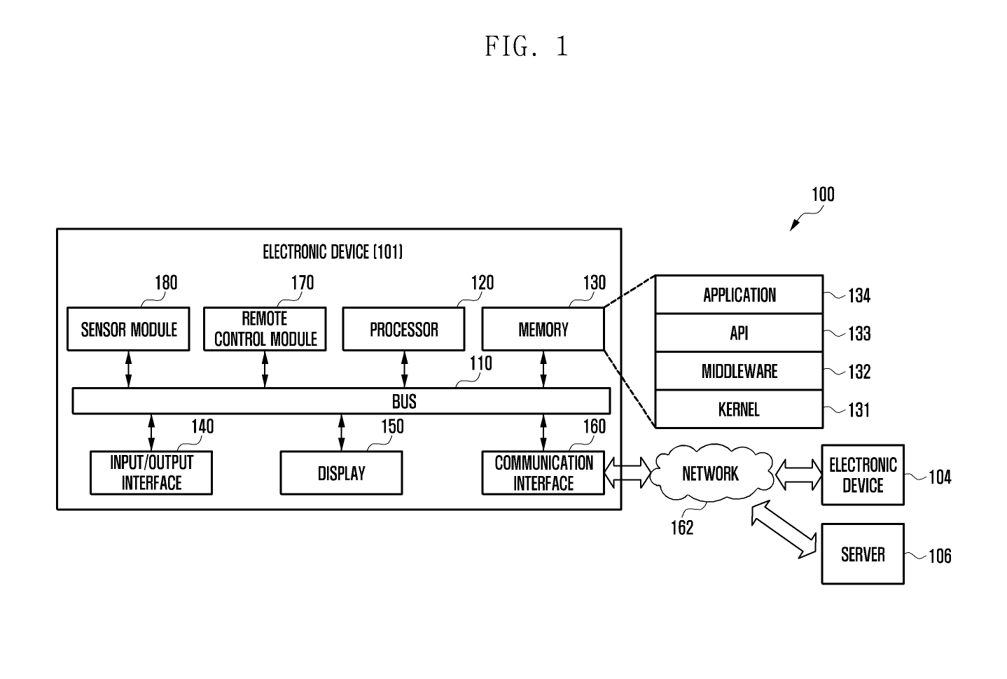

FIG. 1 illustrates a network environment 100 including an electronic device 101 according to various embodiments of the present invention.

Referring to FIG. 1, the electronic device 101 includes a bus 110, a processor 120, a memory 130, an input/output interface 140, a display 150, a communication interface 160, a remote control module 170, and a sensor module 180.

The bus 110 may be a circuit connecting the above described components and transmitting communication (for example, a control message) between the above described components.

The processor 120 receives commands from other components (for example, the memory 130, the input/output interface 140, the display 150, the communication interface 160, the remote control module 170, or the sensor module 180) through the bus 110, analyzes the received commands, and executes calculation or data processing according to the analyzed commands.

The memory 130 stores commands or data received from the processor 120 or other components (for example, the input/output interface 140, the display 150, the communication interface 160, the remote control module 170, or the sensor module 180) or generated by the processor 120 or other components. The memory 130 may include programming modules, for example, a kernel 131, middleware 132, an Application Programming Interface (API) 133, and an application 134. Each of the aforementioned programming modules may be implemented by software, firmware, hardware, or a combination of two or more thereof.

The kernel 131 controls or manages system resources (for example, the bus 110, the processor 120, or the memory 130) used for executing an operation or function implemented by the remaining other programming modules, for example, the middleware 132, the API 133, or the application 134. Further, the kernel 131 provides an interface for accessing individual components of the electronic device 101 from the middleware 132, the API 133, or the application 134 to control or manage the components.

The middleware 132 performs a relay function of allowing the API 133 or the application 134 to communicate with the kernel 131 to exchange data. Further, in operation requests received from the application 134, the middleware 132 performs a control for the operation requests (for example, scheduling or load balancing) by using a method of assigning a priority, by which system resources (for example, the bus 110, the processor 120, the memory 130 and the like) of the electronic device 101 can be used, to the application 134.

The API 133 is an interface by which the application 134 can control a function provided by the kernel 131 or the middleware 132 and includes, for example, at least one interface or function (for example, command) for a file control, a window control, image processing, or a character control.

According to various embodiments, the application 134 may include a Short Message Service (SMS)/Multimedia Messaging Service (MMS) application, an email application, a calendar application, an alarm application, a health care application (for example, application measuring quantity of exercise or blood sugar) or an environment information application (for example, application providing information on barometric pressure, humidity or temperature). Additionally or alternatively, the application 134 may be an application related to an information exchange between the electronic device 101 and an external electronic device (for example, electronic device 104). The application related to the information exchange may include, for example, a notification relay application for transferring particular information to the external electronic device or a device management application for managing the external electronic device.

For example, the notification relay application may include a function of transmitting notification information generated by another application (for example, an SMS/MMS application, an email application, a health care application or an environment information application) of the electronic device 101 to the external electronic device (for example, electronic device 104). Additionally or alternatively, the notification relay application may receive notification information from, for example, the external electronic device 104 and provide the received notification information to the user. The device management application may manage (for example, install, remove, or update) at least a part of functions (for example, turning on/off the external electronic device (or some components of the external electronic device) or controlling a brightness of the display) of the external electronic device (104 communicating with the electronic device 101, an application executed in the external electronic device 104, or a service (for example, call service or message service) provided by the external electronic device 104.

According to various embodiments, the application 134 may include an application designated according to an attribute (for example, type of electronic device) of the external electronic device 104. For example, when the external electronic device 104 is an MP3 player, the application 134 may include an application related to music reproduction. Similarly, when the external electronic device 104 is a mobile medical device, the application 134 may include an application related to health care. According to an embodiment, the application 134 may include at least one of an application designated to the electronic device 101 and an application received from an external electronic device (for example, server 106 or electronic device 104).

The input/output interface 140 transmits a command or data input from the user through an input/output device (for example, a sensor, a keyboard, or a touch screen) to the processor 120, the memory 130, the communication interface 160, the remote control module 170, or a sensor module 180 through, for example, the bus 110. For example, the input/output interface 140 may provide data on a user's touch input through a touch screen to the processor 120. Further, the input/output interface 140 may output a command or data received, through, for example, the bus 110, from the processor 120, the memory 130, the communication interface 160, the remote control module 170, or a sensor module 180 through the input/output device (for example, a speaker or a display). For example, the input/output interface 140 may output voice data processed through the processor 120 to the user through the speaker. The input/output interface 140 may provide an external power input through a charging device (for example, Travel Adaptor, USB charger(e.g. notebook, desk top, etc.), a portable battery charger) to the processor 120, the memory 130, the display 150, the communication interface 160, the remote control module 170, or a sensor module 180.

The display 150 displays various pieces of information (for example, multimedia data, text data, or the like) for the user.

The communication interface 160 connects communication between the electronic device 101 and the external device (for example, electronic device 104 or server 106). For example, the communication interface 160 may access a network 162 through wireless or wired communication to communicate with the external device. The wireless communication includes at least one of, for example, WiFi, BlueTooth (BT), Near Field Communication (NFC), a Global Positioning System (GPS), and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The telecommunication network includes at least one of a computer network, Internet, Internet of things, and a telephone network. According to an embodiment, a protocol (for example, transport layer protocol, data link layer protocol, or physical layer protocol) for communication between the electronic device 101 and the external device may be supported by at least one of the application 134, the application programming interface 133, the middleware 132, the kernel 131, and the communication interface 160.

The remote control module 170 may control the remote control procedure between the electronic device 101 and the other electronic device 104 or between the electronic device 101 and the server 106. For example, when the remote control module 170 detects a remote control gesture for requesting remote control through the sensor module 180, it may request a transmission of control information from the other electronic device 104 or the server 106. The remote control module 170 may receive control information from the other electronic device 104 or the server 106. The remote control module 170 may transmit control commands, input through the control screen, to the other electronic device 104 or the server 106.

The sensor module 180 may detect a shaking, tapping, rotating, etc. of the electronic device 101. The sensor module 180 may include a number of sensors, e.g., a gesture sensor, a gyro sensor, an acceleration sensor, a geomagnetic sensor, a grip sensor, an IR sensor, etc. The sensor module 180 may also detect a remote control gesture for requesting a remote control process.

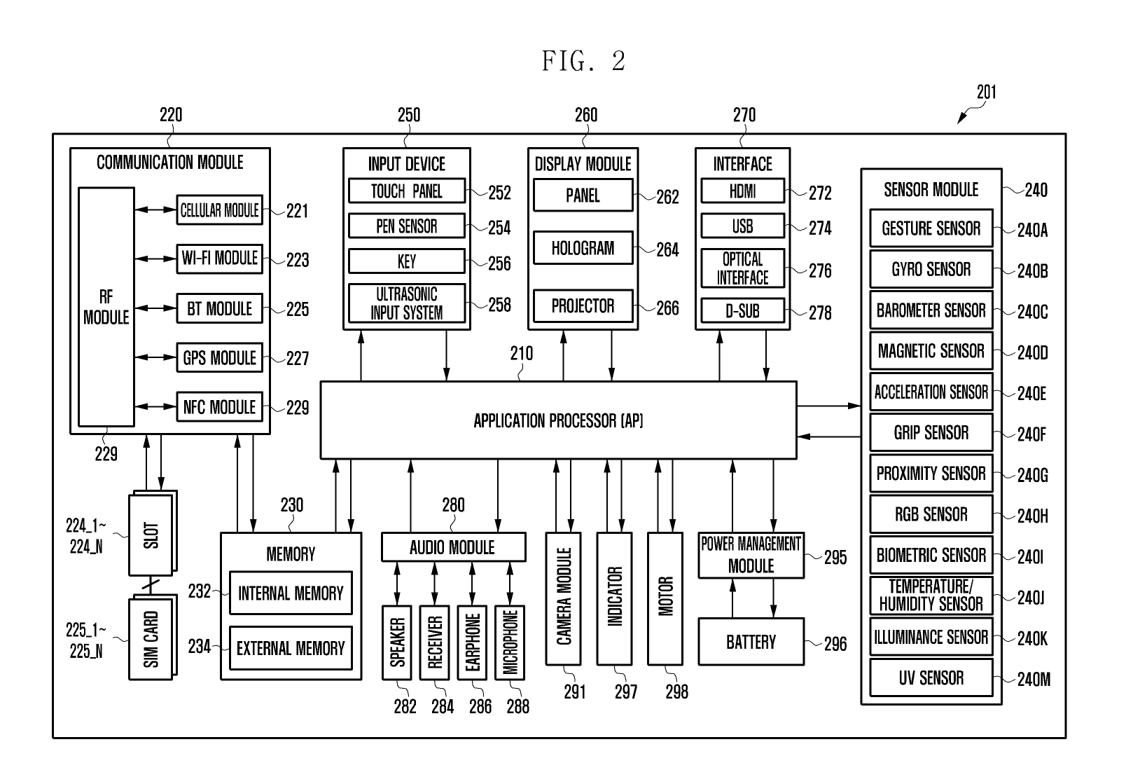

FIG. 2 is a block diagram of an electronic device 201 according to various embodiments of the present invention. The electronic device 201 may configure, for example, a whole or a part of the electronic device 101 illustrated in FIG. 1.

Referring to FIG. 2, the electronic device 201 includes one or more Application Processors (APs) 210, a communication module 220, a Subscriber Identification Module (SIM) card 225_1˜225_N, a memory 230, a sensor module 240, an input device 250, a display 260, an interface 270, an audio module 280, a camera module 291, a power managing module 295, a battery 296, an indicator 297, and a motor 298.

The AP 210 operates an operating system (OS) or an application program so as to control a plurality of hardware or software component elements connected to the AP 210 and execute various data processing and calculations including multimedia data. The AP 210 may be implemented by, for example, a System on Chip (SoC). According to an embodiment, the processor 210 may further include a Graphic Processing Unit (GPU).

The communication module 220 (for example, communication interface 160) transmits/receives data in communication between different electronic devices (for example, the electronic device 104 and the server 106) connected to the electronic device 201 (for example, electronic device 101) through a network. According to an embodiment, the communication module 220 includes a cellular module 221, a WiFi module 223, a BlueTooth (BT) module 225, a Global Positioning System (GPS) module 227, a Near Field Communication (NFC) module 228, and a Radio Frequency (RF) module 229.

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a subscriber identification module (for example, the SIM card 225_1˜225_N). According to an embodiment, the cellular module 221 performs at least some of the functions which can be provided by the AP 210. For example, the cellular module 221 may perform at least some of the multimedia control functions.

According to an embodiment, the cellular module 221 may include a Communication Processor (CP). Further, the cellular module 221 may be implemented by, for example, an SoC. Although the components such as the cellular module 221 (for example, communication processor), the memory 230, and the power managing module 295 are illustrated as components separate from the AP 210 in FIG. 2, the AP 210 may include at least some (for example, cellular module 221) of the aforementioned components in an embodiment.

According to an embodiment, the AP 210 or the cellular module 221 (for example, communication processor) may load a command or data received from at least one of a non-volatile memory and other components connected to each of the AP 210 and the cellular module 221 to a volatile memory and process the loaded command or data. Further, the AP 210 or the cellular module 221 may store data received from at least one of other components or generated by at least one of other components in a non-volatile memory.

Each of the WiFi module 223, the BT module 225, the GPS module 227, and the NFC module 228 may include, for example, a processor for processing data transmitted/received through the corresponding module. Although the cellular module 221, the WiFi module 223, the BT module 225, the GPS module 227, and the NFC module 228 are illustrated as blocks separate from each other in FIG. 2, at least some (for example, two or more) of the cellular module 221, the WiFi module 223, the BT module 225, the GPS module 227, and the NFC module 228 may be included in one Integrated Chip (IC) or one IC package according to one embodiment. For example, at least some (for example, the communication processor corresponding to the cellular module 221 and the WiFi processor corresponding to the WiFi module 223) of the processors corresponding to the cellular module 221, the WiFi module 223, the BT module 225, the GPS module 227, and the NFC module 228 may be implemented by one SoC.

The RF module 229 transmits/receives data, for example, an RF signal. Although not illustrated, the RF module 229 may include, for example, a transceiver, a Power Amp Module (PAM), a frequency filter, a Low Noise Amplifier (LNA) or the like. Further, the RF module 229 may further include a component for transmitting/receiving electronic waves over a free air space in wireless communication, for example, a conductor, a conducting wire, or the like. Although the cellular module 221, the WiFi module 223, the BT module 225, the GPS module 227, and the NFC module 228 share one RF module 229 in FIG. 2, at least one of the cellular module 221, the WiFi module 223, the BT module 225, the GPS module 227, and the NFC module 228 may transmit/receive an RF signal through a separate RF module according to one embodiment.

The SIM cards 225_1˜225_N are a card including a Subscriber Identification Module and may be inserted into a slot formed in a particular portion of the electronic device. The SIM cards 225_1˜225_N include unique identification information (for example, Integrated Circuit Card IDentifier (ICCID)) or subscriber information (for example, International Mobile Subscriber Identity (IMSI).

The memory 230 (for example, memory 130) may include an internal memory 232 or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 201 through various interfaces. According to an embodiment, the electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric sensor 2401, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which can detect an acoustic wave by a microphone (for example, microphone 288) of the electronic device 201 through an input means generating an ultrasonic signal to identify data and can perform wireless recognition. According to an embodiment, the electronic device 201 receives a user input from an external device (for example, computer or server) connected to the electronic device 201 by using the communication module 220.

The display 260 (for example, display 150) includes a panel 262, a hologram device 264, and a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 201. According to an embodiment, the display 260 may further include a control circuit for controlling the panel 262, the hologram device 264, and the projector 266.

The interface 270 includes, for example, a High-Definition Multimedia Interface (HDMI) 272, a Universal Serial Bus (USB) 274, an optical interface 276, and a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 140 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power managing module 295 manages power of the electronic device 201. Although not illustrated, the power managing module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method.

The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (for example, AP 210) of the electronic device 201, for example, a booting status, a message status, a charging status and the like.

The motor 298 converts an electrical signal to a mechanical vibration. Although not illustrated, the electronic device 201 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

The term “module” used in the present disclosure may refer to, for example, a unit including at least one combination of hardware, software, and firmware. The “module” may be interchangeably used with a term, such as unit, logic, logical block, component, and/or circuit. The “module” may be a minimum unit of an integrally configured article and/or a part thereof. The “module” may be a minimum unit performing at least one function and/or a part thereof. The “module” may be mechanically and/or electronically implemented. For example, the “module” according to the present disclosure may include at least one of an Application-Specific ICt (ASIC) chip, a Field-Programmable Gate Arrays (FPGA), and a programmable-logic device for performing operations which has been known and/or are to be developed hereinafter.

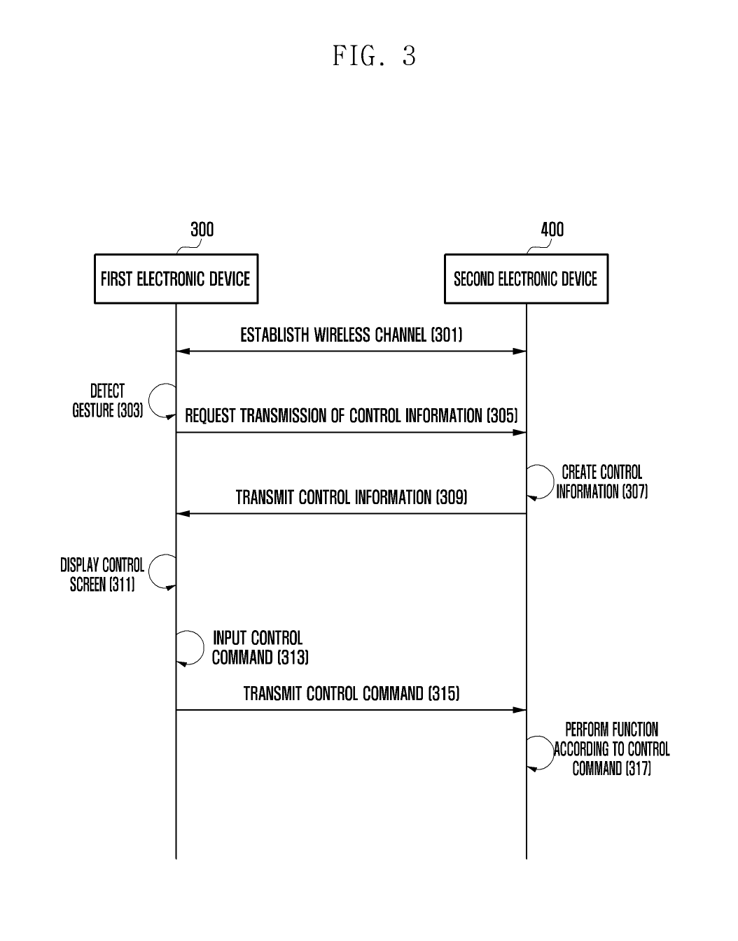

FIG. 3 is a flow chart that describes a remote control method of a remote control system according to embodiments of the present invention.

Referring to FIG. 3, the first electronic device 300 and the second electronic device 400 are wirelessly connected to each other, establishing a wireless channel (301). Examples of the connection of the wireless channel are Bluetooth, Bluetooth Low Energy (BLE), Infrared Data Association (IrDA), Ultra Wide Band (UWB), Zigbee, Wireless Local Area Network (WLAN), Wi-Fi, Wi-Fi Peer to Peer (Wi-Fi P2P), Miracast, Digital Living Network Alliance (DLNA), Home RF, WiDi, Wi-Fi Display (WFD), etc.

The first electronic device 300 may detect a preset gesture (303). An example of the preset gesture may be a shake gesture of the first electronic device 300. It should be understood that the preset gesture is not limited to the shake gesture. That is, the preset gesture may include a various types of gestures, e.g., a tapping gesture, a rotating gesture, a flipping gesture, etc. In the following description, the preset gesture is described based on a shake gesture.

The shake gesture refers to a gesture that is preset to request a transmission of control information for remotely controlling the second electronic device 400 or applications (or functions) supported by the second electronic device 400, by the first electronic device 300. The gesture for requesting to transmission of control information (e.g., a shake gesture) may be set by the electronic device manufacturer or the electronic device user.

In an embodiment, the gesture for requesting remote control may include a number of gestures, e.g., a first gesture for requesting control information about a music playback application, a second gesture for requesting control information about a video playback application, a third gesture for requesting control information about a camera application, etc.

The first electronic device 300 may transmit a transmission request of control information to the second electronic device 400 (305). The control information may be information about an application running on the second electronic device 400 (hereafter called ‘application information’) or a control screen for controlling an application that is running on the second electronic device 400.

The second electronic device 400 may create control information corresponding to the received request of transmission of control information (307). For example, when the second electronic device 400 ascertains that the control information is application information and a music playback application has been running, it may create a message notifying that a music playback application is running, as control information.

When the second electronic device 400 also ascertains that the control information is a control screen, it may create a control screen for controlling an application that is running, as control information. As an example, when a music playback application has been running, the second electronic device 400 may create a control screen for controlling the music playback, as control information. As another example, when a video playback application has been running, the second electronic device 400 may create a control screen for controlling the video playback, as control information.

In an embodiment, when a number of applications are running, the second electronic device 400 may transmit a list of running applications to the first electronic device 300. When the second electronic device 400 receives a request of transmission of control information about one or more applications (that needs to be remotely controlled) from the first electronic device 300, it may create a control screen for the selected application (s) as control information.

In an embodiment, when a number of remote control gestures are made (preset), the second electronic device 400 may detect the types of remote control gestures (or the first electronic device (300) may detect the types of remote control gestures and receive a request of transmission of control screen for an application mapped to the detected gesture from the first electronic device 300). The second electronic device 400 may create a control screen for an application mapped to the detected (received) remote control gesture, as control information. The second electronic device 400 determines whether the application mapped to the detected remote control gesture is running. When the second electronic device 400 ascertains that the application mapped to the detected remote control gesture is running, it may create a control screen for the mapped application as control information. On the contrary, when the second electronic device 400 ascertains that the application mapped to the detected remote control gesture is not run, it may create an error message or a pop-up message asking whether to run the mapped application. The second electronic device 400 may transmit the error message or pop-up message to the first electronic device 300. After that, when the second electronic device 400 receives a message for allowing the operation of the mapped application from the first electronic device 300, it may operate the application and create the control screen as control information.

In an embodiment, when a number of applications are running, the second electronic device 400 may create control information about the latest run application. After that, when transmission request of the control information is re-received, the second electronic device 400 may create control information about the second latest run application. As such, each time that transmission request of control information about an application is received, the second electronic device 400 may create control information about the next application.

In an embodiment, when a number of applications are running, the second electronic device 400 may select applications about which control information will be created, corresponding to the number of shakes. For example, when the type of gesture is a shake gesture and the number of shakes is one, the second electronic device 400 may create control information about the latest run application. When the number of shakes is two, the second electronic device 400 may create control information about the second latest run application.

In an embodiment, when a number of applications are running, the second electronic device 400 may create control information about the applications. For example, the second electronic device 400 may create information about a number of applications. The second electronic device 400 may also create a number of control screens for controlling respective applications. The second electronic device 400 may create control information in such a way to configure a number of control screens with superimposition, overlay or on multiple screens.

The second electronic device 400 may create a control screen considering (reflecting) the screen size (display resolution) of the first electronic device 300. An example of the control screen is a screen reducing a running screen of an application according to the screen size of the first electronic device 300 or a control panel including a forward control, a reward control, a playback/pause control, a volume control, a progress bar showing a progress status, etc.

The second electronic device 400 may transmit the created control information to the first electronic device 300 (309). The first electronic device 300 may display a control screen based on the received control information (311).

For example, when the control information is information about an application that is running, the first electronic device 300 may create and display a control screen for controlling the running application.

When the control information is a control screen, the first electronic device 300 may display the received control screen. When the received control information is a number of control screens, the first electronic device 300 may display the control screens with superimposition, overlay or on multiple screens.

The first electronic device 300 may detect input of a control command (313). The first electronic device 300 may transmit the detected control command to the second electronic device 400 (315). The second electronic device 400 may perform a function corresponding to the control command (317). For example, when the second electronic device 400 receives a control command for turning the volume down, it may turn down the volume.

In an embodiment, the first electronic device 300 may be connected to a number of electronic devices through wireless channels. For example, the first electronic device 300 may be connected to a smart TV, an audio system, a tablet PC, etc., through wireless channels. In that case, the first electronic device 300 may remotely control the wireless connected electronic devices in a similar way as it remotely controls a number of applications that are running on the second electronic device 400 as described above. When the first electronic device 300 detects a remote control gesture, it may request transmission of control information from the latest controlled electronic device or may display a list of connected electronic devices and request transmission of control information from one or more electronic devices selected from the list. When electronic devices are mapped to a number of remote control gestures respectively and the first electronic device 300 detects remote control gestures, it may request transmission of control information from the electronic device corresponding to the detected remote control gestures. When the remote control gesture is a shake gesture, the first electronic device 300 may request transmission of control information from one of the electronic devices according to the number of shakes. The first electronic device 300 may request transmission of control information from a number of connected electronic devices and display a number of control screens with superimposition or on multiple screens. Each time that the first electronic device 300 detects a remote control gesture, it may request transmission of control information from a number of connected electronic devices in order.

As described above, the embodiments of the present invention may allow users to simply, rapidly control the second electronic device 400 by gestures input to the first electronic device 300. The embodiments of the present invention may allow users to rapidly control a number of applications (or functions) running on the second electronic device 400 by the first electronic device 300.

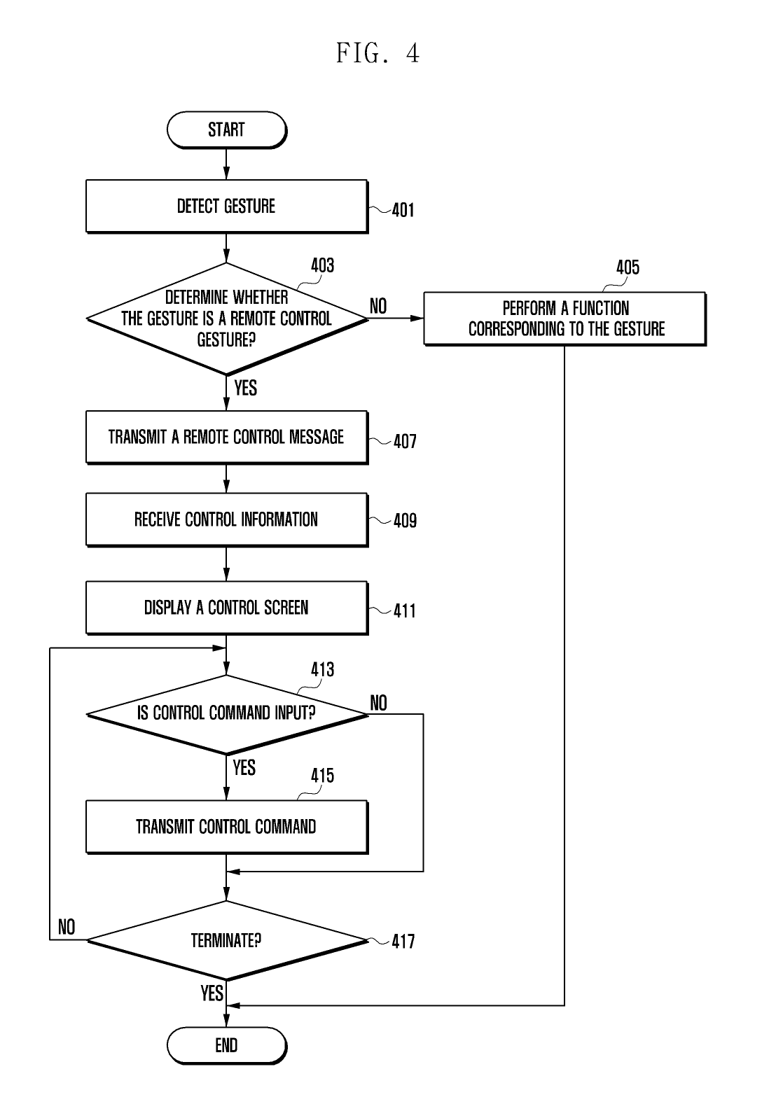

FIG. 4 is a flow chart that describes a remote control method of a first electronic device according to embodiments of the present invention. The following embodiment is explained, assuming that the first electronic device 300 and the second electronic device 400 are connected to each other through a wireless channel.

Referring to FIG. 4, the first electronic device 300 may detect a gesture through a sensor module (401). The gesture may be made to the sensor module when the first electronic device 300 is in a sleep state (or a state where the screen is turned off) or an idle state (or a state where the screen is tuned on). When the sensor module detects a gesture while the first electronic device 300 is in a sleep state, it may wake up and turn on the screen. For example, the first electronic device 300 may wake up and turn on to a lock screen or a unlock screen according to the settings.

The first electronic device 300 may determine whether the detected gesture is a gesture for performing a remote control process (i.e., a remote control gesture) (403). To do this, the first electronic device 300 may compare the detected gesture with a stored remote control gesture and determine whether they are identical (or similar) to each other.

When the first electronic device 300 ascertains that the detected gesture is not a remote control gesture in operation 403, it may perform a function corresponding to the detected gesture (405). For example, when the detected gesture is a gesture for unlocking the lock screen, the first electronic device 300 may release the lock state.

On the contrary, when the first electronic device 300 ascertains that the detected gesture is a remote control gesture in operation 403, it may transmit a remote control message for requesting transmission of control information to the second electronic device 400 (407). The control information may be information about an application that is running or a control screen for controlling an application that is running. For example, the first electronic device 300 may request information about one or more applications that are running on the second electronic device 400 to the second electronic device 400. The first electronic device 300 may also request transmission of a control screen for an application (or function) that is running on the second electronic device 400 to the second electronic device 400.

In an embodiment, when the number of remote control gestures is more than two, the first electronic device 300 may detect a type of a remote control gesture, identify an application mapped to the detected the type of the remote control gesture, and request a transmission of a control screen for the mapped application to the second electronic device 400. When the mapped application is not run on the second electronic device 400, the first electronic device 300 may receive an error message or a pop-up message asking whether to run the mapped application from the second electronic device 400. When the user selects an option to operate the mapped application, the first electronic device 300 may transmit a message for requesting operation of the mapped application and transmission of a control screen for the mapped application to the second electronic device 400.

In an embodiment, when the detected remote control gesture is a shake gesture, the first electronic device 300 may detect the number of shakes, and request transmission of control information corresponding to the shake number. For example, when the number of shakes is one, the first electronic device 300 may request transmission of control information about the latest run application to the second electronic device 400. When the number of shakes is two, the first electronic device 300 may request transmission of control information about the second latest run application to the second electronic device 400.

The first electronic device 300 receives control information from the second electronic device 400 (409). The first electronic device 300 may display a control screen based on the received control information (411).

In an embodiment, when a number of applications has been running on the second electronic device 400, the first electronic device 300 may receive a list of applications that have been running from the second electronic device 400 before operation 409 and may transmit a request of transmission of control screens for applications selected from the list to the second electronic device 400.

In an embodiment, when the first electronic device 300 has received a control screen for a particular application and then re-detects the remote control gesture, it may transmits a request of transmission of a control screen for an application next to the particular application to the second electronic device 400.

In an embodiment, when a number of applications are running on the second electronic device 400, the first electronic device 300 may receive a number of control screens, and display them with superimposition or on multiple screens.

The first electronic device 300 determines whether a control command is input to the control screen (413). When the first electronic device 300 ascertains that a control command is input to the control screen in operation 413, it may transmit it to the second electronic device 400 (415).

The first electronic device 300 determines whether a request is made to terminate the remote control process (417). When the first electronic device 300 ascertains that a request is not made to terminate the remote control process in operation 417, it returns to operation 413. On the contrary, when the first electronic device 300 ascertains that a request is made to terminate the remote control process in operation 417, it terminates the remote control procedure.

Meanwhile, when the first electronic device 300 ascertains that a control command is not input to the control screen in operation 413, it proceeds with operation 417.

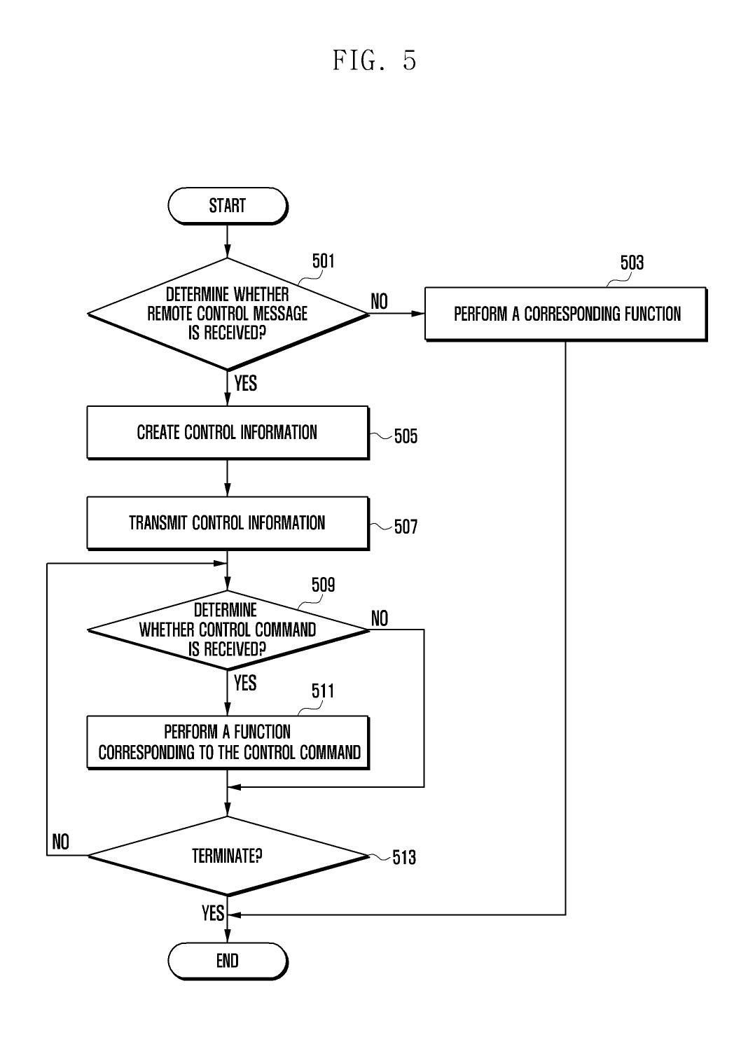

FIG. 5 is a flow chart that describes a remote control method of a second electronic device according to embodiments of the present invention. The following embodiment is explained, assuming that the first electronic device 300 and the second electronic device 400 are connected to each other through a wireless channel.

Referring to FIG. 5, the second electronic device 400 determines whether to receive a remote control message for requesting transmission of control information to perform remote control (501). When the second electronic device 400 ascertains that a remote control message is not received in operation 501, it performs a corresponding function (503). For example, the second electronic device 400 may operate in standby mode or may perform a user's requested functions, e.g., music playback, video playback, Internet access, etc.

On the contrary, when the second electronic device 400 ascertains that a remote control message is received in operation 501, it may create control information (505). For example, the second electronic device 400 may create information about an application (function) that is running or a control screen.

In an embodiment, when a number of applications are running on the second electronic device 400, the second electronic device 400 may transmit a list of running applications to the first electronic device 300. When the second electronic device 400 receives a selection of a particular application (that needs to be remotely controlled) from the first electronic device 300, it may create a control screen for the selected application.

In an embodiment, when a number of remote control gestures are made (preset), the second electronic device 400 determines whether an application mapped to the detected remote control gesture is running. When the second electronic device 400 ascertains that an application mapped to the detected remote control gesture is running, it may create a control screen for the mapped application. On the contrary, when the second electronic device 400 ascertains that an application mapped to the detected remote control gesture is not run, it may create an error message or a pop-up message asking whether to run the mapped application. The second electronic device 400 may transmit the error message or pop-up message to the first electronic device 300. When the second electronic device 400 transmits the pop-up message to the first electronic device 300 and then receives a message for allowing its operation of the mapped application from the first electronic device 300, it may operate the mapped application and create a control screen for the mapped application.

In an embodiment, when a number of applications are running, the second electronic device 400 may create control information about the latest run application. When transmission request of the control information is re-received, the second electronic device 400 may create control information about the second latest run application. As such, each time that transmission request of control information about an application is received, the second electronic device 400 may create control information about the next application.

In an embodiment, when a number of applications are running, the second electronic device 400 may select applications about which control information will be created, corresponding to the number of shakes. For example, when the type of detected gesture is a shake gesture and the number of shakes is one, the second electronic device 400 may create control information about the latest run application. When the number of shakes is two, the second electronic device 400 may create control information about the second latest run application.

In an embodiment, the second electronic device 400 may create a number of control screens for controlling respective applications and control them through the screens. The second electronic device 400 may configure a number of control screens with superimposition or on multiple screens.

The second electronic device 400 may create a control screen considering the screen size (display resolution) of the first electronic device 300. An example of the control screen is a screen reducing a running screen of an application according to the screen size of the first electronic device 300 or a control panel including the forward control, the reward control, the playback/pause control, the volume control, the progress bar showing the video playback status, etc.

The second electronic device 400 transmits the control information to the first electronic device 300 (507). The second electronic device 400 determines whether to receive a control command from the first electronic device 300 (509). When the second electronic device 400 has received a control command from the first electronic device 300 in operation 509, it performs a function corresponding to the received control command (511).

The second electronic device 400 determines whether a request is made to terminate the remote control process (513). When the second electronic device 400 ascertains that a request has not been made to terminate the remote control process in operation 513, it returns to operation 509. On the contrary, when the second electronic device 400 ascertains that a request has been made to terminate the remote control process in operation 513, it terminates the remote control procedure.

Meanwhile, when the second electronic device 400 has not received a control command from the first electronic device 300 in operation 509, it proceeds with operation 513.

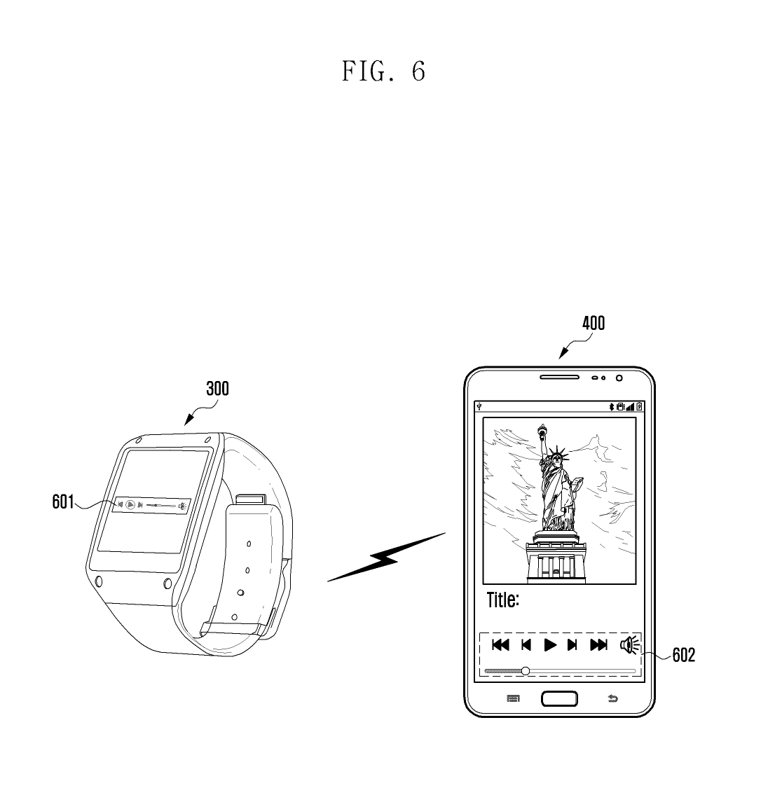

FIGS. 6 to 9 are views of remote control screens according to embodiments of the present invention.

Referring to FIG. 6, when the second electronic device 400 is running a music playback application, the first electronic device 300 may display a control screen for controlling the music playback application. The first electronic device 300 may display a first control panel 601 on the screen. The second electronic device 400 may display a second control panel 602 with a number of functions on the bottom portion of the music playback screen. The first control panel 601 may include part of the functions of the second control panel 602, considering the screen size of the first electronic device 300. It should be, however, understood that, when the screen size of the first electronic device 300 is not considered or is sufficiently large, the first control panel 601 may be identical to the second control panel 602.

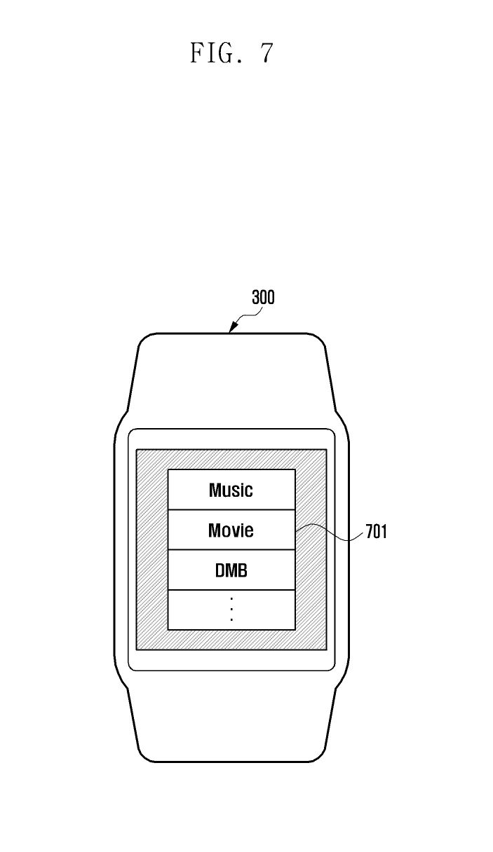

Referring to FIG. 7, when the second electronic device 400 is running a number of applications, the first electronic device 300 may display a list 701 of the applications. The user may select one or more applications from the list on the first electronic device 300 and remotely controls the selected application (applications) of the second electronic device 400.

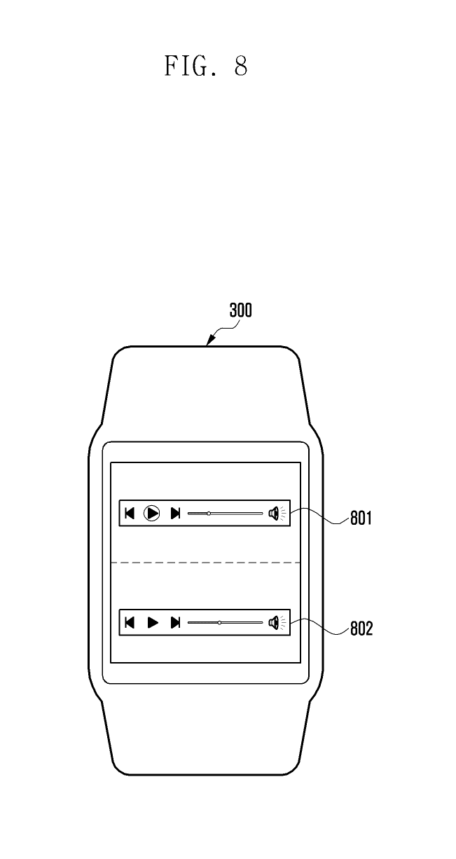

Referring to FIG. 8, when the second electronic device 400 is running a number of applications, the first electronic device 300 may display the corresponding control screens using the multiple screens. For example, the first electronic device 300 splits the screen into the top and bottom halves and displays a third control panel 801 and a fourth control panel 802 on the top and bottom halves of the screen, respectively. It should be understood that the screen may be split into the right and left halves. It should also be understood that the screen may be split into four sections, top, bottom, right and left. It should be understood that the screen may be split into five or more sections.

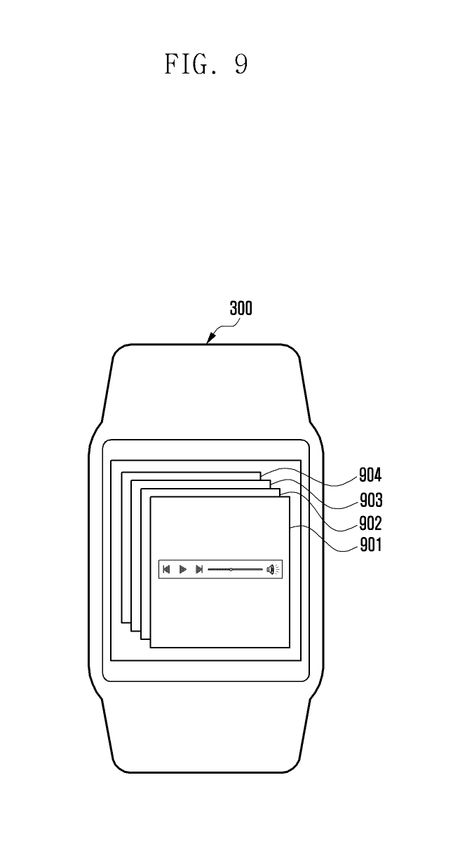

Referring to FIG. 9, when the second electronic device 400 is running a number of applications, the first electronic device 300 may display a number of control screens corresponding to the applications with superimposition. For example, as shown in FIG. 9, when four applications are running on the second electronic device 400, the first electronic device 300 may display a first control screen 901 for a first application, a second control screen 902 for a second application, a third control screen 903 for a third application, and a fourth control screen 904 for a fourth application, which are superimposed one on another, or in cascade mode.

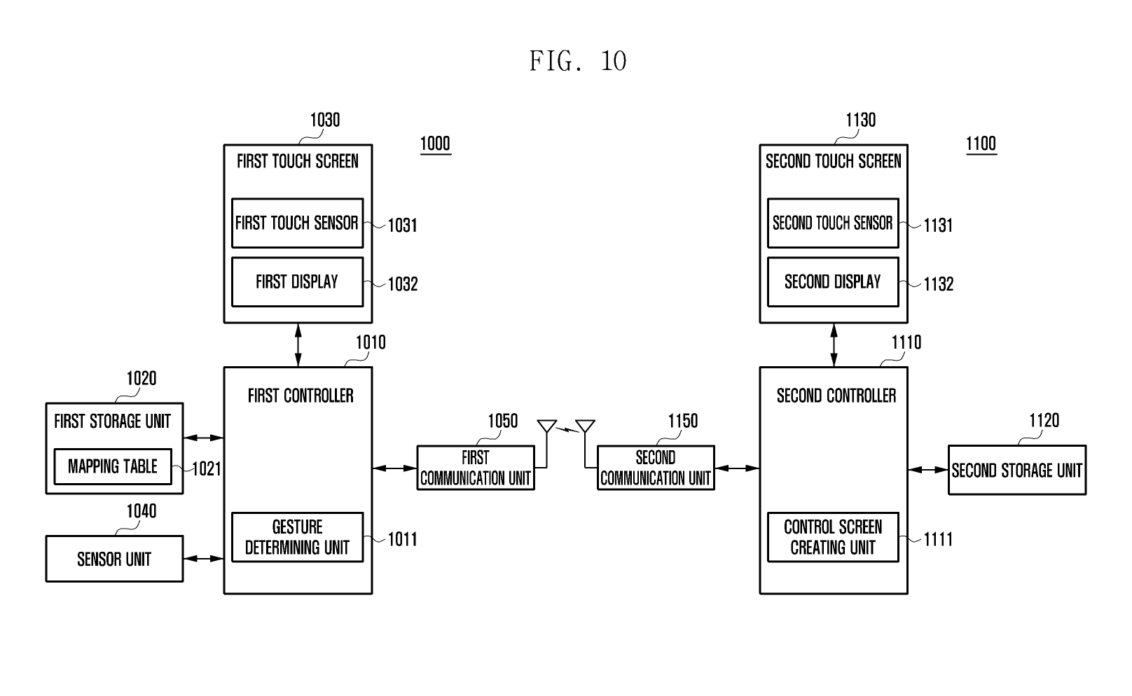

FIG. 10 is schematic block diagrams of first 300 and second 400 electronic devices according to embodiments of the present invention.

Referring to FIG. 10, the first electronic device 1000 may include a first controller 1010, a first storage unit 1020, a first touch screen 1030, a sensor unit 1040 and a first communication unit 1050. The first controller 1010 may include a gesture determining unit 1011. The first storage unit 1020 may include a mapping table 1021. The first touch screen 1030 may include a first touch sensor 1031 and a first display 1032.

The first controller 1010 may control the entire operation of the first electronic device 1000 and signal flows among the components in the first electronic device 1000. The first controller 1010 may also process data in the first electronic device 1000. The first controller 1010 may include a central processing unit (CPU), an application processor (AP), etc. The first controller 1010 may also be implemented with a single core processor or multi-core processor.

The first controller 1010 may control the remote control procedure shown in FIG. 4. For example, the first controller 1010 detects a preset gesture through the sensor unit 1040. To this end, the first controller 1010 may include a gesture determining unit 1011.

The gesture determining unit 1011 may recognize a gesture based on a detection signal from the sensor unit 1040 and determine whether the recognized gesture is a remote control gesture. For example, the gesture determining unit 1011 determines whether the recognized gesture is identical (or similar) to a stored remote control gesture. When the gesture determining unit 1011 ascertains that the recognized gesture is identical (or similar) to a stored remote control gesture, it concludes that the recognized gesture is a remote control gesture. When a number of remote control gestures have been set, the gesture determining unit 1011 compares a recognized gesture with the preset remote control gestures and determines a type of remote control gesture corresponding to the recognized gesture.

When the gesture determining unit 1011 of the controller 1010 ascertains that the recognized gesture is a remote control gesture, the controller 1010 transmits a remote control message for requesting transmission of control information for performing a remote control process to the second electronic device 1100 through the first communication unit 1050.

The first controller 1010 receives control information from the second electronic device 1100 and displays it on the first display 1032. When the received control information is information about an application that is running on the second electronic device 1100, the controller 1010 creates and displays a control screen for remotely controlling the application. When the received control information is a control screen for controlling the running application, the first controller 1010 displays the control screen on the first display 1032.

When the controller 1010 receives control commands through the control screen, it transmits them to the second electronic device 1100.

The first storage unit 1020 may store an operating system (OS) for the first electronic device 1000 and applications for various option functions, e.g., an audio playback function, image or video playback function, Internet access function, text messaging function, map service function, etc. The first storage unit 1020 may store data, e.g., videos, games, music, movies, maps, etc. The first storage unit 1020 may also store remote control application software for carrying out a remote control procedure according to embodiments of the present invention. The remote control application software includes a number of routines for: recognizing a gesture, determining whether the recognized gesture is a remote control gesture, requesting transmission of control information for remote control, displaying a control screen based on the received control information, transmitting control commands, etc.

The first storage unit 1020 may store a mapping table 1021. The mapping table 1021 may be configured in such a way that applications or functions are mapped to remote control gestures, correspondingly, respectively. The mapping table 1021 may be set when the first electronic device 1000 is manufactured. The mapping table 1021 may be created or altered by electronic device users. For example, an electronic device user may set remote control gestures as he/she like and map them to applications or functions, correspondingly, respectively.

The first touch screen 1030 performs an input function and a displaying function. To this end, the first touch screen 1030 includes a first touch sensor 1031 and a first display 1032.

The first touch sensor 1031 is a device that detects inputs. The first touch sensor 1031 detects events that occurred by contact or proximity of input tools, e.g., a user's finger, stylus pen, etc., creates the signals and transmits them to the first controller 1010. The first touch sensor 1031 detects the presence of an event, or the change in physical quantity (e.g., capacitance, resistance, etc.) according to the proximity or contact of an input tool, and transmit information about type and location of the event (e.g., tap, drag, flick, long touch, double touch, multi-touch, etc.) to the first controller 1010. For example, the first touch sensor 1031 detects a touch input to the control screen and transmits the touch signal to the first controller 1010.

The first display 1032 displays menus of the first electronic device 1000 and information input by the user or information provided to the user. The first display 1032 may be implemented with a Liquid Crystal Display (LCD), an Organic Light Emitting Diode (OLED), an Active Matrix Organic Light Emitting Diodes (AMOLED), or the like. The first display 1032 displays a variety of screens according to the use of the first electronic device 1000, e.g., a home screen, a menu screen, a web page screen, a call screen, etc. The first display 1032 also displays various control screens during the remote control process, e.g., screens as shown in FIGS. 6 to 9.

The sensor unit 1040 detects remote control gestures for requesting a remote control process. For example, the sensor unit 1040 detects a detection signal according to a shaking, tapping, rotating, etc. of the first electronic device 1000 and transmits it to the first controller 1010. The sensor unit 1040 may include a number of sensors, e.g., a gesture sensor, a gyro sensor, an acceleration sensor, a geomagnetic sensor, a grip sensor, an IR sensor, etc.

The first communication unit 1050 includes one or more modules for communicating with the second electronic device 1100 in wireless mode, e.g., a mobile communication module, Wireless Local Area Network (WLAN) module, short-range communication module, etc. Examples of the short-range communication module are a Bluetooth module, Bluetooth Low Energy (BLE) module, Infrared Data Association (IrDA) module, etc.

The first communication unit 1050 transmits/receive data related to a remote control process (e.g., screen data, control commands, etc.) to/from the second electronic device 1100. For example, the first communication unit 1050 transmits a request of transmission of control information for a remote control process to the second electronic device 1100 and receives the control information therefrom. The first communication unit 1050 transmits control commands to the second electronic device 1100.

Referring to FIG. 10, the second electronic device 1100 may include a second controller 1110, a second storage unit 1120, a second touch screen 1130, and a second communication unit 1150. The controller 1110 may include a control screen creating unit 1111. The second touch screen 1130 may include a second touch sensor 1131 and a second display 1132.

The second controller 1110 may control the entire operation of the second electronic device 1100 and signal flows among the components in the second electronic device 1100. The second controller 1110 may also process data in the second electronic device 1100. The second controller 1110 may include a central processing unit (CPU), an application processor (AP), etc. The second controller 1110 may also be implemented with a single core processor or multi-core processor.

The second controller 1110 may control the remote control procedure shown in FIG. 5. To this end, the second controller 1110 may include a control screen creating unit 1111.

The control screen creating unit 1111 creates a control screen to be transmitted to the first electronic device 1000, e.g., a control screen of an application (function) that is running, a control screen of an application mapped to a remote control gesture, a control screen of an application selected from the list of applications, etc. The control screen creating unit 1111 creates a number of control screens and configures them with superimposition or on multiple screens.

The control screen creating unit 1111 determines the size of a control screen based on the screen size (display resolution) of the first electronic device 1000. For example, the control screen creating unit 1111 may create a control screen by reducing a running screen of an application of the second electronic device 1100. The control screen creating unit 1111 may create a control screen with a control panel including part of the control functions, e.g., a forward control, a reward control, a playback/pause control, a volume control, etc.

The second storage unit 1120 may store an operating system (OS) for the second electronic device 1100 and applications for various option functions, e.g., an audio playback function, image or video playback function, Internet access function, text messaging function, map service function, etc. The second storage unit 1120 may store data, e.g., videos, games, music, movies, maps, etc. The second storage unit 1120 may also store remote control application software for carrying out a remote control procedure according to embodiments of the present invention. The remote control application software includes a number of routines for: creating control information, performing functions according to control commands, etc.

The second touch screen 1130 performs an input function and a displaying function. To this end, the second touch screen 1130 includes a second touch sensor 1131 and a second display 1132.

The second touch sensor 1131 is a device that detects inputs. The second touch sensor 1131 detects events that occurred by contact or proximity of input tools, e.g., a user's finger, stylus pen, etc., creates the signals and transmits them to the second controller 1110.

The second display 1132 displays menus of the second electronic device 1100 and information input by the user or information provided to the user. The second display 1132 may be implemented with a Liquid Crystal Display (LCD), an Organic Light Emitting Diode (OLED), an Active Matrix Organic Light Emitting Diodes (AMOLED), or the like. The second display 1132 displays a variety of screens according to the use of the second electronic device 1100, e.g., a home screen, a menu screen, a web page screen, a call screen, etc.

The second communication unit 1150 includes one or more modules for communicating with the first electronic device 1000 in wireless mode, e.g., a mobile communication module, Wireless Local Area Network (WLAN) module, short-range communication module, etc. Examples of the short-range communication module are a Bluetooth module, Bluetooth Low Energy (BLE) module, Infrared Data Association (IrDA) module, etc.

The second communication unit 1150 transmits/receive data related to a remote control process (e.g., screen data, control commands, etc.) to/from the first electronic device 1000. For example, the second communication unit 1150 receives a request of transmission of control information for a remote control process from the first electronic device 1000 and transmits the control information thereto. The second communication unit 1150 receives control commands from the first electronic device 1000.

Although it is not shown in FIG. 10, it should be understood that the first electronic device 1000 and the second electronic device 1100 may further include components equivalent to the units listed above. For example, the first electronic device 1000 and second electronic device 1100 may be configured to selectively further include modules with add-on functions: a camera module for taking still images or moving images; a broadcast module for receiving broadcasts; a digital audio source playback module, such as an MP3 player module; etc.

Part of the method (e.g., operations) or system (e.g., modules or functions) according to the embodiments of the present invention can be implemented with instructions as programming modules that are stored in computer-readable storage media. One or more processors can execute instructions, thereby performing the functions. An example of the computer-readable storage media may be memory. Part of the programming modules can be implemented (executed) by processor. Part of the programing module may include modules, programs, routines, sets of instructions or processes, etc., in order to perform one or more functions.

Examples of computer-readable media include: magnetic media, such as hard disks, floppy disks, and magnetic tape; optical media such as Compact Disc Read Only Memory (CD-ROM) disks and Digital Versatile Disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to the embodiments of the present invention may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations

Although exemplary embodiments of the invention have been described in detail above, it should be understood that many variations and modifications of the basic inventive concept herein described, which may be apparent to those skilled in the art, will still fall within the spirit and scope of the exemplary embodiments of the invention as defined in the appended claims.

1. A remote control method comprising:
detecting, by a first electronic device, a gesture corresponding to a preset gesture;
transmitting, by the first electronic device, a remote control message to a second electronic device through a wireless channel established between the first and second electronic devices, wherein the remote control message is a request for transmission of control information for controlling one or more applications or functions running on the second electronic device;
receiving the control information from the second electronic device; and
displaying a control screen based on the received control information.

2. The method of claim 1, wherein the transmitting of the remote control message comprises:
determining whether the detected gesture is a remote control gesture for requesting a remote control process; and
transmitting, when the detected gesture is the remote control gesture for requesting the remote control process, the remote control message to the second electronic device.

3. The method of claim 1, wherein the receiving of the control information comprises:
receiving control information for controlling an application that is running on the second electronic device.

4. The method of claim 1, wherein the receiving of the control information comprises:
receiving a list of a number of applications that are running on the second electronic device from the second electronic device; and
requesting transmission of control screens for controlling one or more applications selected from the list to the second electronic device, and receiving the control screens for the selected applications from the second electronic device.

5. The method of claim 1, wherein the receiving of the control information comprises:
determining, when a number of applications are running on the second electronic device, a type of the detected gesture; and
receiving a control screen for an application mapped to the determined type of the detected gesture.

6. The method of claim 5, wherein the receiving of a control screen for the application mapped to the determined type of the detected gesture comprises:
receiving, when the application mapped to the determined type of the detected gesture is running on the second electronic device, a control screen for the application; and
receiving, when the application mapped to the determined type of the detected gesture is not running on the second electronic device, an error message or a pop-up message asking whether to run the application.

7. The method of claim 1, wherein the receiving of the control information comprises:
receiving, when a number of applications are running on the second electronic device, control information for the running number of applications.

8. The method of claim 7, wherein the display of control information comprises:
displaying a number of control screens with superimposition, overlay or on multiple screens.

9. The method of claim 1, wherein the receiving of the control information comprises:
altering, when a number of applications are running on the second electronic device, control information for the running applications, in order, each time that a gesture is detected.

10. The method of claim 1, wherein the receiving of the control information comprises:
receiving, when the preset gesture is a shake gesture and a number of applications are running on the second electronic device, control information about one of the applications according to the number of shakes.

11. A remote control method comprising:
receiving, by a second electronic device, a remote control message from a first electronic device through a wireless channel established between the first and second electronic devices, wherein the remote control message is a request for transmission of control information for controlling one or more applications or functions running on the second electronic device;
creating control information for controlling one or more applications or functions; and
transmitting the created control information to the first electronic device.

12. The method of claim 11, wherein the creating of the control information comprises:
creating a control screen with at least part of the entire functions, based on the screen size of the first electronic device.

13. The method of claim 11, further comprising:
receiving a control command from the first electronic device; and
performing a function corresponding to the received control command.

14. An electronic device comprising:
a sensor unit for detecting a gesture;
a communication unit for establishing a wireless channel with another electronic device;
a controller for controlling the communication unit: to transmit, when the detected gesture is a preset gesture, a remote control message to the other electronic device through the wireless channel, wherein the remote control message is a request for transmission of control information for controlling one or more applications or functions running on the other electronic device; and to receive the control information from the other electronic device; and
a display for displaying a control screen based on the received control information.

15. The electronic device of claim 14, wherein the controller: determines whether the detected gesture is the remote control gesture for requesting a remote control process; and transmits, when the detected gesture is the remote control gesture for requesting the remote control process, the remote control message to the other electronic device.

16. The electronic device of claim 14, wherein:
the number of preset gesture is two or more; and
the electronic device further comprises:
a storage unit for storing a mapping table where the applications are mapped to the gestures, correspondingly, respectively.

17. The electronic device of claim 14, wherein the controller: receives a list of a number of applications that are running on the other electronic device from the other electronic device; and requests transmission of control screens for controlling one or more applications selected from the list.

18. The electronic device of claim 14, wherein:
the controller receives control information about a number of applications that are running on the other electronic device from the other electronic device; and
the display displays a number of control screens, based on the received control information, with superimposition, overlay or on multiple screens.

19. The electronic device of claim 14, wherein the controller receives, when the preset gesture is a shake gesture and a number of applications are running on the other electronic device, control information about one of the applications according to the number of shakes.

20. A remote control system comprising:
a first electronic device; and
a second electronic device connected to the first electronic device through a wireless channel,
wherein:
the first electronic device detects a gesture corresponding to a preset gesture, transmits a request of transmission of control information about one or more applications to the second electronic device through the wireless channel, and receives the control information from the second electronic device; and
the second electronic device creates control information about one or more applications according to the received request of transmission of control information and transmits the created control information to the first electronic device.
